(19) United States
(12) Patent Application Publication
(10) Pub. No.: US 2021/0334434 A1
(43) Pub. Date: Oct. 28, 2021

(54) OPTIMIZATION METHOD FOR DENSE CUTTING, TEMPORARY PLUGGING AND FRACTURING IN SHALE HORIZONTAL WELL STAGE

(71) Applicant: Southwest Petroleum University, Chengdu (CN)

(72) Inventors: Zhaozhong YANG, Chengdu (CN); Changxin YANG, Chengdu (CN); Xiaogang LI, Chengdu (CN); Liangping YI, Chengdu (CN); Yuting HE, Chengdu (CN)

(73) Assignee: Southwest Petroleum University, Chengdu City (CN)

(21) Appl. No.: 17/098,292

(22) Filed: Nov. 13, 2020

(30) Foreign Application Priority Data
Apr. 24, 2020 (CN) 2020103295039

(51) Int. Cl. G06F 30/20; E21B 49/00; E21B 47/00; E21B 43/26

(52) U.S. Cl. CPC G06F 30/20; E21B 49/00; G06F 2111/10; E21B 43/26; E21B 2200/20; E21B 47/00

(57) ABSTRACT

Disclosed is an optimization method for dense cutting, temporary plugging and fracturing in shale horizontal well stage. The optimization method includes steps of obtaining reservoir parameters, completion parameters, and fracturing construction parameters, establishing a fluid-solid coupling model of hydraulic fracturing through a discontinuous displacement method, establishing a fracture propagation model for dense cutting, temporary plugging and fracturing in shale horizontal well stage, calculating geometric parameters of dense cutting, temporary plugging and fracturing fractures in shale horizontal well stage based on the reservoir parameters, the completion parameters, and the fracturing construction parameters, optimizing the construction parameters of dense cutting, temporary plugging and fracturing in shale horizontal well stage based on the geometric parameters of hydraulic fractures after dense cutting, temporary plugging and fracturing in stage and results temporary plugging operations.

### TECHNICAL FIELD

The disclosure relates to a staged multi-cluster fracturing technology for shale reservoir horizontal well in petroleum engineering, and more specifically to a simulation for horizontal well staged fracturing multi-fracture propagation and an optimization method for dense cutting, temporary plugging and fracturing in shale horizontal well stage.

### BACKGROUND

The development of society is inseparable from the support of energy, and energy supply is related to national security. With the continuous development of China's economy, the demand for oil and gas resources has increased year by year, and the gap between domestic oil and gas resource output and foreign oil and gas resource import has been increasing, which has caused huge hidden dangers to the country's economic development and energy security. With the advent of the new era, development concepts, such as innovation, coordination and green, dominate the main theme of national economic development, and at the same time put forward new requirements for China's energy consumption. On the premise that the development of conventional oil and gas resources cannot meet domestic demand, speeding up the exploration and development of unconventional energy sources, such as tight oil and gas, shale oil and gas, coalbed methane, and natural gas hydrate, has become an important task for China's oil and gas resource development. Shale gas refers to the natural gas that exists in the organic shale and its interlayer in an adsorbed and free state. China's shale gas resources are abundant and widely distributed, with technically recoverable reserves of approximately 21.8 trillion cubic meters. Accelerating the development and utilization of shale gas resources can effectively fill the gap in domestic natural gas resources and is of great significance to safeguarding national energy security. Shale reservoirs have the characteristics of low porosity and low permeability. Industrial airflow cannot be obtained using conventional oil and gas extraction techniques. It is necessary to modify the shale reservoirs to realize the effective exploitation of shale gas. Hydraulic fracturing is a key technology to realize the commercial exploitation of shale gas. By combining horizontal well drilling technology and hydraulic fracturing technology, shale reservoirs are reconstructed to form sand-filled fractures with high conductivity in the reservoirs, increase the exposed area of the reservoir, effectively reduce the seepage distance of shale gas in the pores, and greatly increase the production of a single well. The shale reservoir is highly heterogeneous and has a large number of natural fractures. The artificial fractures produced by hydraulic fracturing will connect these natural fractures to form a complex fracture network during the expansion and extension process, which can greatly improve the development effect of shale gas. For shale reservoirs with large in-situ stress difference and strong heterogeneity, conventional horizontal well staged fracturing technology is difficult to form a complex hydraulic fracture network, and the development effect of shale gas is poor. In response to the difficulty of forming a complex closure network, some scholars proposed to increase the density of hydraulic fractures by shortening the cluster spacing during multi-cluster fracturing in a horizontal well stage, and to cut the reservoir densely to fully “break” the reservoir and increase the desorption rate of large shale gas. For the difficult problem of hydraulic fracture propagation under strong stress interference, temporary plugging of fractures is used to limit the amount of fluid entering the dominant fractures, forcing the fracturing fluid to enter the suppressed fractures, and realize the re-propagation of the suppressed fractures. It can effectively improve the effect of shale gas development under the condition that it is difficult to form fracture network in shale reservoirs. At present, the dense cutting, temporary plugging and fracturing technology in horizontal well stage is not yet mature. There are few reports about dense cutting, temporary plugging and fracturing on-site operations in China. The law of re-expansion of restrained fractures after temporary plugging is still unclear. And it causes great difficulties to construction design of temporary plugging and fracturing. Therefore, numerical simulation methods are used to study the extension characteristics of dense cutting, temporary plugging and fracturing fractures in shale horizontal wells, and the construction parameters of the dense cutting, temporary plugging and fracturing technology are optimized, which is of great significance to improve the transformation effect of shale reservoirs with large in-situ stress difference and strong heterogeneity.

### SUMMARY

The disclosure is an optimization method for dense cutting, temporary plugging and fracturing in shale horizontal well stage. The optimization method considers the influence of stress interference between fractures, natural fractures, and fracturing fluid loss, optimizes the construction parameters of the dense cutting, temporary plugging and fracturing process in the immature horizontal well stage, and improves applicability of the dense cutting and temporary plugging process in the reconstruction of shale storage. The optimization method achieves the purpose of optimizing the construction design and improving the development effect.

The technical solution provided by the disclosure to solve the shortcomings existing in the conventional technology is an optimization method for dense cutting, temporary plugging and fracturing in shale horizontal well stage, including the following steps:
S10: obtaining reservoir parameters, completion parameters, and fracturing construction parameters;
S20: establishing a fluid-solid coupling model of hydraulic fracturing through a displacement discontinuity method;
S30: establishing a fracture propagation model for dense cutting, temporary plugging and fracturing in shale horizontal well stage;
S40: calculating geometric parameters of dense cutting, temporary plugging and fracturing fractures in shale horizontal well stage based on the reservoir parameters, the completion parameters, and the fracturing construction parameters;
S50: optimizing the construction parameters of dense cutting, temporary plugging and fracturing in shale horizontal well stage based on results of fractures propagation and temporary plugging operations.

A flow field model of the fluid-solid coupling model of hydraulic fracturing in the step S20 is:

$$\{ \begin{matrix}{p}_{pf} = \frac{0.2369 {ρ}_{s}}{{n}^{2} {d}^{4} {c}^{2}} {Q}_{c}^{2} \\ \frac{\partial p}{\partial s} = {2}^{{n}^{′} + 1} {{k}^{′} ( \frac{1 + 2 {n}^{′}}{{n}^{′}} )}^{{n}^{′}} {h}^{- {n}^{′}} {w}^{- ( 2 {n}^{′} + 1 )} {Q}^{{n}^{′}}\end{matrix} \\ {\int }_{0}^{t} {Q}_{T} ( t ) dt = {\sum }_{i = 1}^{N} {\int }_{0}^{{L}_{i} ( t )} hwds + {\sum }_{i}^{N} {\int }_{0}^{{L}_{i} ( t )} {\int }_{0}^{t} \frac{2 {C}_{L}}{\sqrt{t - τ ( s )}} dtds$$

in the formula, Q_{c} is fracturing fluid flow rate through a perforation; Q is fracturing fluid flow rate in the hydraulic fracture; Q_{T} is total fracturing fluid flow rate during fracturing construction process; p_{pf} is the friction at a horizontal wellbore perforation; p is the flow friction of the fracturing fluid in hydraulic fractures; n′ is fluid power law exponent; k′ is fluid viscosity index; ρₛ is the density of the fracturing fluid; n is a number of perforations; d is perforation diameter; c is flow coefficient; L is the length of the hydraulic fracture; h is theheight of the hydraulic fracture; w is the width of the hydraulic fracture; N is the number of the hydraulic fractures; C_{L} is leak off coefficient for the fracturing fluid; t is a current fracturing time; τ is the fracture element opening time.

A stress field model of the fluid-solid coupling model of hydraulic fracturing in the step S20 is:

$$\{ \begin{matrix}{{σ}^{i}}_{s} = {\sum }_{j = 1}^{N} {T}^{ij} {{A}^{ij}}_{ss} {{D}^{j}}_{s} + {\sum }_{j = 1}^{N} {T}^{ij} {{A}^{ij}}_{sn} {{D}^{j}}_{n} \\ {{σ}^{i}}_{n} = {\sum }_{j = 1}^{N} {T}^{ij} {{A}^{ij}}_{ns} {{D}^{j}}_{s} + {\sum }_{j = 1}^{N} {T}^{ij} {{A}^{ij}}_{nn} {{D}^{j}}_{n}\end{matrix} \\ {T}^{ij} = 1 - \frac{{d}_{ij}^{3}}{{[ {d}_{ij}^{2} + {( h \text{/} 2 )}^{2} ]}^{1.5}}$$

in the formula, N is a total number of hydraulic fracture elements; ^{ij}A is a boundary strain influence coefficient matrix, describing the influence of a displacement discontinuity of the j-th fracture element on a stress of the i-th fracture element; σⁱ is a stress generated at the i-th fracture element caused by the displacement discontinuity of the j-th fracture unit; σₛ and σₙ are the tangential and normal stress along the fracture element, respectively; Dₛ and Dₙ respectively are the discontinuity of the tangential and normal displacement of the fracture unit; T^{ij} is a fracture height correction coefficient, used for correction the influence of the fracture height in the two-dimensional fracture model; h is fracture height; dᵢⱼ is the distance between the midpoint of the i-th fracture element and the j-th fracture element.

Further, the fracture propagation model for dense cutting, temporary plugging and fracturing in shale horizontal well stage in the step S30 is:

$${K}_{e} = \frac{1}{2} cos ( \frac{α}{2} ) [ {K}_{I} ( 1 + cos ( α ) ) - 3 {K}_{II} sin ( α ) ]$$

$$\{ \begin{matrix}{K}_{I} = \frac{0.806 E \sqrt{π}}{4 ( 1 - {v}^{2} ) \sqrt{2 a}} {D}_{n}^{Tip} \\ {K}_{II} = \frac{0.806 E \sqrt{π}}{4 ( 1 - {v}^{2} ) \sqrt{2 a}} {D}_{s}^{Tip}\end{matrix} \\ \{ \begin{matrix}{σ}_{xx} = {σ}_{H} - \frac{{K}_{I}}{\sqrt{2 π r}} cos \frac{θ}{2} ( 1 - sin \frac{θ}{2} sin \frac{3 θ}{2} ) + \frac{{K}_{II}}{\sqrt{2 π r}} sin \frac{θ}{2} ( 2 + cos \frac{θ}{2} cos \frac{3 θ}{2} ) \\ {σ}_{yy} = {σ}_{H} - \frac{{K}_{I}}{\sqrt{2 π r}} cos \frac{θ}{2} ( 1 + sin \frac{θ}{2} sin \frac{3 θ}{2} ) - \frac{{K}_{II}}{\sqrt{2 π r}} sin \frac{θ}{2} cos \frac{θ}{2} cos \frac{3 θ}{2} \\ {τ}_{xy} = 0 - \frac{{K}_{I}}{\sqrt{2 π r}} sin \frac{θ}{2} cos \frac{θ}{2} cos \frac{3 θ}{2} - \frac{{K}_{II}}{\sqrt{2 π r}} cos \frac{θ}{2} ( 1 - sin \frac{θ}{2} sin \frac{3 θ}{2} ) \end{matrix} \\ \{ \begin{matrix}{σ}_{r} = \frac{{σ}_{xx} + {σ}_{yy}}{2} + \frac{{σ}_{xx} - {σ}_{yy}}{2} cos 2 θ + {τ}_{xy} sin 2 θ \\ {σ}_{θ} = \frac{{σ}_{xx} + {σ}_{yy}}{2} - \frac{{σ}_{xx} - {σ}_{yy}}{2} cos 2 θ - {τ}_{xy} sin 2 θ \\ {τ}_{r θ} = {τ}_{xy} cos 2 θ - \frac{{σ}_{xx} - {σ}_{yy}}{2} sin 2 θ \end{matrix} \\ {p}_{nf} > {σ}_{nf} + {σ}_{T} \\ \vert {τ}_{nf} \vert > {τ}_{0} + {K}_{f} ( {σ}_{nf} - {p}_{nf} )$$

in the formula, Kₑ is equivalent stress intensity factor; α is an angle of the fracture element; E is Young's modulus; v is Poisson's ratio; a is a half-length of the fracture element; Dₙ^{Tip} and Dₛ^{Tip} respectively are discontinuous quantity of normal and tangential displacements of the fracture tip element; σₓₓ, σ_{yy} and τ_{xy} respectively are stress field at a natural fracture caused by induced stress and in-situ stress in the Cartesian coordinate system; σᵣ, σ^{θ} and τ_{rθ} respectively are stress field at a natural fracture in the polar coordinate system established by transforming from σₓₓ, σ_{yy} and τ_{xy} to taking a contact point as a origin point; σ_{H} and σₕ are the maximum and minimum horizontal principal stresses of the shale reservoir respectively; r is the polar diameter in the polar coordinate system; θ is the approach angle between hydraulic fractures and natural fracture; K_{I} and K_{II} respectively are type I (tension type) and type II (shear type) stress intensity factor; p_{nf} is the fluid pressure at the intersection of hydraulic fractures and natural fractures; σ_{nf} and τ_{nf} respectively are the normal and tangential stress on a natural fracture wall; σ_{T} and τ₀ respectively are a tensile and shear strength of the natural fracture; K_{f} is a friction coefficient of the natural fracture wall.

The advantages of the disclosure are: the disclosure is based on the displacement discontinuity method, considering the interaction between hydraulic fractures and natural fractures, the stress interference between fractures and the influence of fracturing fluid filtration, establishes the fracture propagation model for dense cutting, temporary plugging and fracturing in shale horizontal well stage to quickly calculates the geometric parameters of hydraulic fractures in the fracturing process, and accurately obtains the fracture propagation rules after temporary plugging under different construction conditions. The disclosure optimizes the construction parameters such as the number of temporary plugging operations and fracturing fluid displacement in the process based on the goal of realizing the effective expansion of each cluster of fractures and forming effective fractures, and it provides theoretical guidance and practice for the actual engineering application of this process.

### BRIEF DESCRIPTION OF THE DRAWINGS

FIG. 1 is a flow chart of solving the fracture propagation model for dense cutting, temporary plugging and optimizing construction parameters.

FIG. 2 is a schematic diagram of natural fracture distribution.

FIG. 3 is a fracturing fluid flow model during dense cutting, temporary plugging and fracturing.

FIG. 4 is a schematic diagram of hydraulic fracture approaching natural fracture.

FIG. 5 is a simulation result of five clusters of fractures with dense cutting, temporary plugging and fracturing fracture propagation under a displacement of 12 m³/min.

FIG. 6 is a simulation result of five clusters of fractures with dense cutting, temporary plugging and fracturing fracture propagation under a displacement of 14 m³/min.

FIG. 7 is a simulation result of seven clusters of fractures with dense cutting, temporarily plugging and fracturing fracture propagation under a displacement of 12 m³/min.

FIG. 8 is a simulation result of seven clusters of fractures with dense cutting, temporary plugging and fracturing fracture propagation under a displacement of 14 m³/min.

FIG. 9 is a simulation result of seven clusters of fractures with dense cutting, temporary plugging and fracturing fracture propagation under a displacement of 16 m³/min.

### DETAILED DESCRIPTION OF EMBODIMENTS

According to the description of the content of the disclosure, the construction displacement in the construction parameters is taken as an example of the optimization target parameters, and the disclosure is further described by the first embodiment, the second embodiment and the drawings.

### Embodiment 1

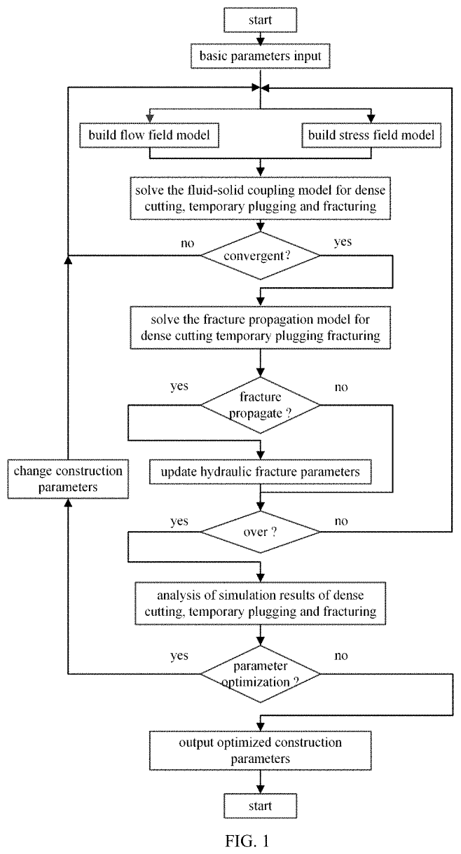

Referring to FIG. 1, the main content of the disclosure is an optimization method for dense cutting, temporary plugging and fracturing in shale horizontal well stage, and the main steps include:

S10: obtaining reservoir parameters, completion parameters, and fracturing construction parameters.

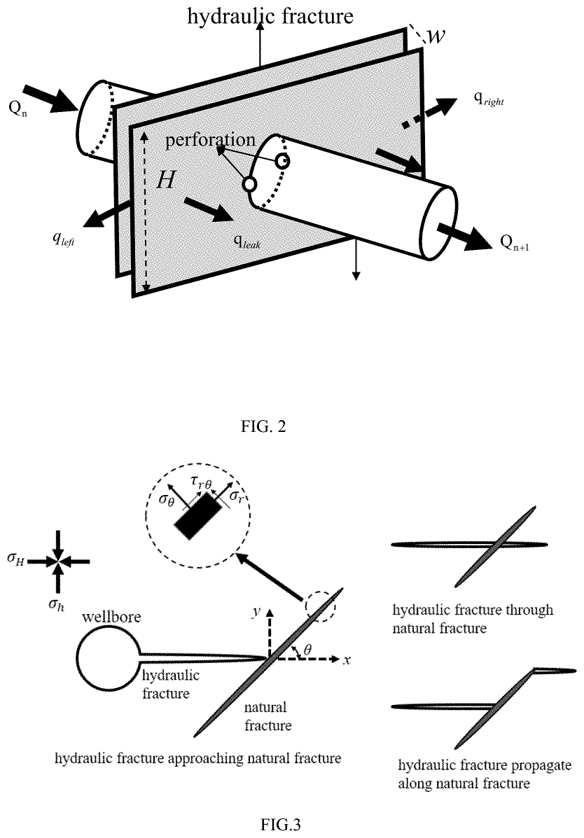

Among them, the reservoir parameters include reservoir thickness, Young's modulus, shear modulus, Poisson's ratio, horizontal maximum principal stress, horizontal minimum principal stress, fracture toughness of reservoir rock and the average length, angle, density, tensile strength, shear strength, fracture surface friction coefficient, etc. of natural fractures; the completion parameters include perforation cluster number, perforation number and perforation diameter; the construction parameters include fracturing fluid rheological parameters, construction displacement, etc. To illustrate the optimization method of the disclosure, Embodiment 1 uses the relevant geological parameters of a shale reservoir in Well Y in a certain block of Jianghan Oilfield. Referring to Table 1, natural fractures are randomly generated, and the distribution diagram is shown in FIG. 2.

TABLE 1

| parameter | unit | value |
|---|---|---|
| horizontal maximum principal stress | MPa | 58.0 |
| horizontal minimum principal stress | MPa | 52.0 |
| Young's modulus | MPa | 37.5 |
| Poisson's ratio | — | 0.20 |
| reservoir thickness | m | 50.0 |
| fluid loss coefficient | m/min^{0.5} | 3.0 × 10⁻⁴ |
| fracturing fluid density | kg/m3 | 1.0 × 10³ |
| fracturing fluid flux | m³/min | 12 |
| fluid power law exponent | — | 1.0 |
| fluid viscosity index | mPa · s^{n′} | 1.0 |
| rock toughness | MPa · m^{0.5} | 1.2 |
| perforation number | — | 16 |
| perforation diameter | m | 0.012 |
| perforation cluster number | — | 5 |
| cluster spacing | m | 10 |
| tensile strength of natural fracture | MPa | 1.0 |
| shear strength of natural fracture | MPa | 1.9 |
| fracture surface friction coefficient of | — | 0.32 |
| natural fracture | | |
| approach angle | ° | 60 |
| average fracture length of natural | m | 8 |
| fracture | | |

S20: establishing a fluid-solid coupling model of hydraulic fracturing through a displacement discontinuity method.

The fracturing fluid flow model during the dense cutting, temporary plugging and fracturing process in a horizontal well stage is shown in FIG. 3, which mainly includes the flow of fracturing fluid thorough the perforation and the flow of fracturing fluid in hydraulic fractures. The flow field model in fluid-solid coupling is:

$$\{ \begin{matrix}{p}_{pf} = \frac{0.2369 {ρ}_{s}}{{n}^{2} {d}^{4} {c}^{2}} {Q}_{c}^{2} \\ \frac{\partial p}{\partial s} = {2}^{{n}^{′} + 1} {{k}^{′} ( \frac{1 + 2 {n}^{′}}{{n}^{′}} )}^{{n}^{′}} {h}^{- {n}^{′}} {w}^{- ( 2 {n}^{′} + 1 )} {Q}^{{n}^{′}}\end{matrix} \\ {\int }_{0}^{t} {Q}_{T} ( t ) dt = {\sum }_{i = 1}^{N} {\int }_{0}^{{L}_{i} ( t )} hwds + {\sum }_{i}^{N} {\int }_{0}^{{L}_{i} ( t )} {\int }_{0}^{t} \frac{2 {C}_{L}}{\sqrt{t - τ ( s )}} dtds$$

In the formula, Q_{c} is fracturing fluid fluxthrough thr perforation; Q is a fracturing fluidflux inside the hydraulic fracture; Q_{T} is a total fracturing fluid flow during fracturing construction process; p_{pf} is the friction at a horizontal wellbore perforation; p is a flow friction of the fracturing fluid in hydraulic fractures; n′ is a fluid power law exponent; k′ is a fluid viscosity index; ρₛ is fracturing fluid density; n is the number of perforations; d is the perforation diameter; c is the flow coefficient; L is the fracture length of the hydraulic fracture; h is the fracture height of the hydraulic fracture; w is fracture width of the hydraulic fracture; N is the number of the hydraulic fractures; C_{L} is thefluid loss coefficient for the fracturing fluid; t is the current fracturing construction time; τ is a fracture opening time.

Among them, based on the discontinuous displacement method, the stress field model in the fluid-solid coupling model is:

$$\{ \begin{matrix}{{σ}^{i}}_{s} = {\sum }_{j = 1}^{N} {T}^{ij} {{A}^{ij}}_{ss} {{D}^{j}}_{s} + {\sum }_{j = 1}^{N} {T}^{ij} {{A}^{ij}}_{sn} {{D}^{j}}_{n} \\ {{σ}^{i}}_{n} = {\sum }_{j = 1}^{N} {T}^{ij} {{A}^{ij}}_{ns} {{D}^{j}}_{s} + {\sum }_{j = 1}^{N} {T}^{ij} {{A}^{ij}}_{nn} {{D}^{j}}_{n}\end{matrix} \\ {T}^{ij} = 1 - \frac{{d}_{ij}^{3}}{{[ {d}_{ij}^{2} + {( h \text{/} 2 )}^{2} ]}^{1.5}}$$

In the formula, N is a total number of hydraulic fracture elements; ^{ij}A is the boundary strain influence coefficient matrix, describing the influence of a displacement discontinuity of the jth fracture unit on a stress of the i-th fracture unit; τⁱ is the stress generated at the ith fracture element by the displacement discontinuity of the jth fracture element; σₛ and σₙ respectively is the tangential and normal stress along the fracture element; Dₛ and Dₙ respectively are the discontinuity of the tangential and normal displacement of the fracture unit; T^{ij} is a fracture height correction coefficient, used for correction the influence of the fracture height in the two-dimensional fracture model; h is fracture height; dᵢⱼ is the distance between the midpoint of the ith fracture unit and the jth fracture unit.

S30: establishing a fracture propagation model for dense cutting, temporary plugging and fracturing in shale horizontal well stage.

When the hydraulic fracture is not approach to the natural fracture, the fracture propagation criterion is the maximum circumferential stress criterion. By calculating the equivalent stress intensity factor Kₑ of the fracture tip unit, when the Kₑ value is greater than the fracture toughness of the rock, the fracture propagates.

$${K}_{e} = \frac{1}{2} cos ( \frac{α}{2} ) [ {K}_{I} ( 1 + cos ( α ) ) - 3 {K}_{II } sin ( α ) ]$$

$$\{ \begin{matrix}{K}_{I} = \frac{0.806 E \sqrt{π}}{4 ( 1 - {v}^{2} ) \sqrt{2 a}} {D}_{n}^{Tip} \\ {K}_{II} = \frac{0.806 E \sqrt{π}}{4 ( 1 - {v}^{2} ) \sqrt{2 a}} {D}_{s}^{Tip}\end{matrix}$$

In the formula, Kₑ is an equivalent stress intensity factor; α is an angle of the fracture unit; E is Young's modulus; v is Poisson's ratio; a is a half-length of the fracture unit; Dₙ^{Tip} and Dₛ^{Tip} respectively are discontinuous quantity of normal and shear displacements of a fracture tip unit; K_{I} and K_{II} respectively are type I (tension type) and type II (shear type) stress intensity factor.

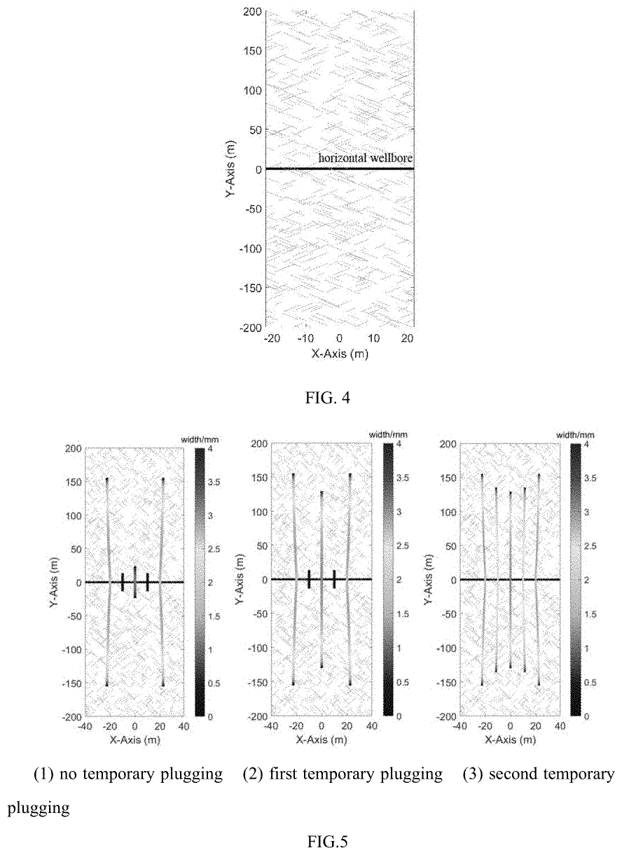

When the hydraulic fracture approaches the natural fracture, the schematic diagram of the interaction between the two is shown in FIG. 4. The combined stress field of the induced stress generated by the hydraulic fracture and the in-situ stress on the natural fracture wall is:

$$\{ \begin{matrix}{σ}_{xx} = {σ}_{H} - \frac{{K}_{I}}{\sqrt{2 π r}} cos \frac{θ}{2} ( 1 - sin \frac{θ}{2} sin \frac{3 θ}{2} ) + \frac{{K}_{II}}{\sqrt{2 π r}} sin \frac{θ}{2} ( 2 + cos \frac{θ}{2} cos \frac{3 θ}{2} ) \\ {σ}_{yy} = {σ}_{H} - \frac{{K}_{I}}{\sqrt{2 π r}} cos \frac{θ}{2} ( 1 + sin \frac{θ}{2} sin \frac{3 θ}{2} ) - \frac{{K}_{II}}{\sqrt{2 π r}} sin \frac{θ}{2} cos \frac{θ}{2} cos \frac{3 θ}{2} \\ {τ}_{xy} = 0 - \frac{{K}_{I}}{\sqrt{2 π r}} sin \frac{θ}{2} cos \frac{θ}{2} cos \frac{3 θ}{2} - \frac{{K}_{II}}{\sqrt{2 π r}} cos \frac{θ}{2} ( 1 - sin \frac{θ}{2} sin \frac{3 θ}{2} ) \end{matrix}$$

In the formula, aₓₓ, σ_{yy} and τ_{xy} respectively is a stress field at a natural fracture caused by induced stress and in-situ stress in the Cartesian coordinate system; σ_{H} and σₕ are the maximum and minimum horizontal principal stresses of the shale reservoir respectively; r is the polar diameter in the polar coordinate system; θ is the approach angle between hydraulic fractures and natural fracture.

The stress field in the above rectangular coordinate system is transformed into a polar coordinate system established with the contact point of the hydraulic fracture and the natural fracture as the origin. The stress field at the natural fracture is:

$$\{ \begin{matrix}{σ}_{r} = \frac{{σ}_{xx} + {σ}_{yy}}{2} + \frac{{σ}_{xx} - {σ}_{yy}}{2} cos 2 θ + {τ}_{xy} sin 2 θ \\ {σ}_{θ} = \frac{{σ}_{xx} + {σ}_{yy}}{2} - \frac{{σ}_{xx} - {σ}_{yy}}{2} cos 2 θ - {τ}_{xy} sin 2 θ \\ {τ}_{r θ} = {τ}_{xy} cos 2 θ - \frac{{σ}_{xx} - {σ}_{yy}}{2} sin 2 θ \end{matrix}$$

In the formula, σᵣ, σ_{θ} and τ_{rθ} respectively are stress field at a natural fracture in the polar coordinate system established by transforming from σₓₓ, σ_{yy} and τ_{xy} to taking a contact point as a origin point.

When the hydraulic fracture is approaching the natural fracture, the criterion for judging the hydraulic fracture passing through the natural fracture is:

p_{nf}>σ_{nf}+σ_{T}

In the inequality, p_{nf} is the fluid pressure at the intersection of the hydraulic fracture and the natural fracture; σ_{nf} is the normal stress on the wall of the natural fracture; UT is the tensile strength of the natural fracture.

When the hydraulic fracture is approaching the natural fractures, the criteria for judging the hydraulic fracture along the natural fracture is:

|τ_{nf}|>τ₀+K_{f}(σ_{nf}−p_{nf})

In the inequality, τ_{nf} is the tangential stress on the wall of the natural fracture; τ₀ is the shear strength of the natural fracture; K_{f} is the friction coefficient of the wall of the natural fracture.

S40: calculating geometric parameters of dense cutting, temporary plugging and fracturing fractures in shale horizontal well stage based on the reservoir parameters, the completion parameters, and the fracturing construction parameters.

Under the condition of a construction rateo 12 m³/min, five clusters of hydraulic fractures are subjected to dense cutting, tempor ary plugging and fracturing fracture propagation numerical at various stages. Referring to FIG. 5, the simulation result includes the fracture geometry distribution results from three different stages of temporary plugging, including no temporary plugging, the first temporary plugging, and the second temporary plugging.

S50: optimizing the construction parameters of dense cutting, temporary plugging and fracturing in shale horizontal well stage based on results of fracture extension and temporary plugging operations.

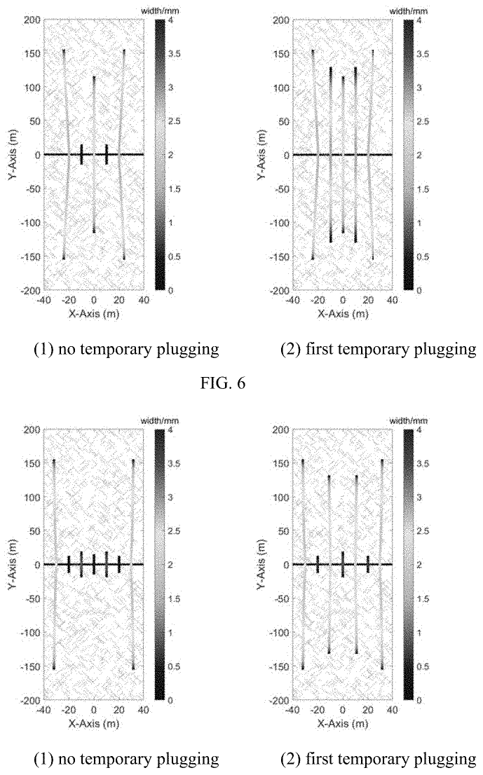

When the displacement is 12 m³/min, the completion of the temporary plugging and fracturing of five clusters of fractures requires two temporary plugging operations, and the fracture width obtained after the second operation is relatively low. In order to reduce the number of temporary plugging operations, increase the success rate of fracturing operations, and increase the fracture width after fracturing, the construction parameters need to be optimized and adjusted. Now increase the construction displacement to 14 m³/min, and the results obtained after the numerical simulation of dense cutting, temporary plugging and fracturing fracture propagation are shown in FIG. 6, including the fracture geometry morphological distribution results at two different stages of no temporary plugging and the first temporary plugging. It can be found that after increasing the displacement, the number of temporary plugging operations decreases, the number of uniform fracture propagations in the non-temporary plugging phase increases, and the average fractures width increases. Therefore, based on the above simulation parameters, for the dense cutting, temporary plugging and fracturing of five clusters of fractures, to reduce the number of temporary plugging operations and increase the average fracture width of the fractures, the construction displacement should be maintained at 14 m³/min and above after optimization.

### Embodiment 2

In order to further illustrate the optimization method of the disclosure, the construction displacement is still used as an optimization parameter, and the embodiment 2 is modified on the basis of the embodiment 1 to increase the number of fractures clusters from five clusters to seven clusters, and perform construction displacement optimization of dense cutting, temporary plugging and fracturing.

S10: obtaining reservoir parameters, completion parameters, and fracturing construction parameters.

The parameters in the Embodiment 2 are as shown in Table 1. Only the number of fracture clusters is changed to seven clusters, the distribution of natural fractures does not change, and the distribution pattern in FIG. 2 is still adopted.

S20: establishing a fluid-solid coupling model of hydraulic fracturing through a displacement discontinuity method.

Under the condition of seven clusters of fractures, the process of establishing a fluid-solid coupling model for dense cutting, temporary plugging and fracturing in horizontal well is consistent with the process in Embodiment 1.

S30: establishing a fracture propagation model for dense cutting, temporary plugging and fracturing in shale horizontal well stage.

Under the condition of seven clusters of fractures, the fracture propagation model for dense cutting, temporary plugging and fracturing in shale horizontal well stage does not change, which is the same as the propagation model in the Embodiment 1.

S40: calculating geometric parameters of dense cutting, temporary plugging and fracturing fractures in shale horizontal well stage based on the reservoir parameters, the completion parameters, and the fracturing construction parameters.

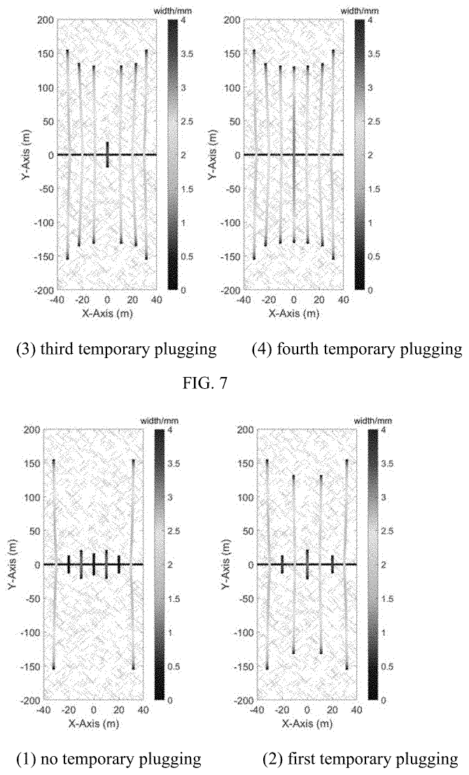

Under the condition of a construction displacement of 12 m³/min, seven clusters of hydraulic fractures are subjected to dense cutting, temporary plugging and fracturing fracture propagation numerical at various stages. Referring to FIG. 7, the simulation result includes the fracture geometry distribution results from four different stages of temporary plugging, including no temporary plugging, the first temporary plugging, the second temporary plugging, and the third temporary plugging.

S50: optimizing the construction parameters of dense cutting, temporary plugging and fracturing in shale horizontal well stage based on results of fracture extension and temporary plugging operations.

Under the condition of a construction flow rate of 12 m³/min, three temporary plugging operations are required to complete the temporary plugging and fracturing of seven clusters of fractures, and the number of temporary plugging is greater than that of five clusters of fractures. At this flow rate, except for the remaining one cluster of fractures propagation after the third temporary plugging operation, there are only two symmetrical propagation of fractures in the rest of the state, indicating that the simultaneous propagation of two more fractures cannot be achieved under this displacement. Because there are multiple hydraulic fractures in a single stage, the hydraulic fractures formed by the first propagation will have a strong inter-fracture interference effect on the hydraulic fractures formed by the later propagation, so that the average fracture width of the hydraulic fractures obtained by the dense cutting, temporary plugging and fracturing at this displacement is small, which is not conducive to proppant transportation during fracturing.

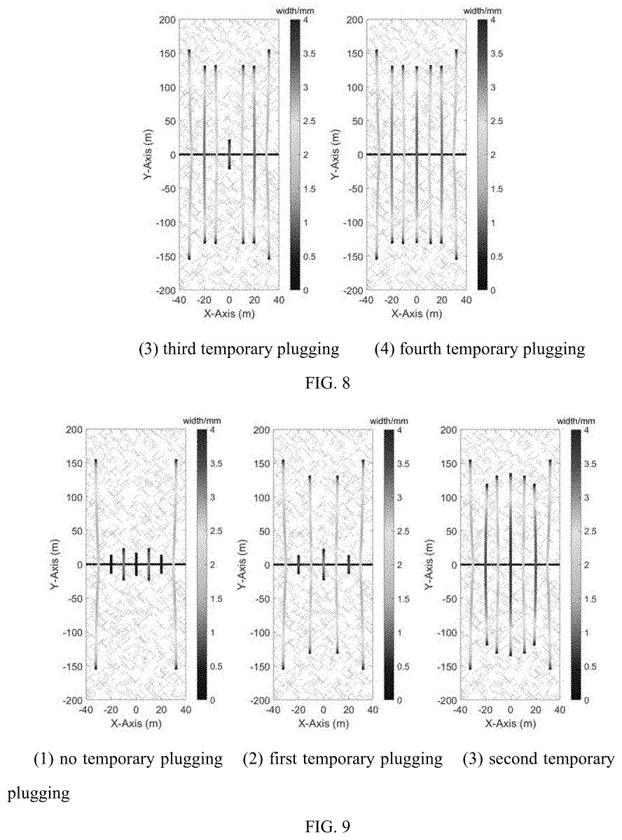

In order to increase the number of fracture propagations at the same time, reduce the number and time of temporary plugging operations, and increase the average fracture width at the same time, the construction displacement is now optimized. Without changing the other parameters, the construction displacement is changed from 12 m³/min to 14 m³/min and 16 m³/min respectively. The simulation calculation results of each stage are shown in FIG. 8 and FIG. 9. It can be found that when the construction flow rate is increased to 14 m³/min, the number of temporary plugging operations has not changed, and three temporary plugging operations are still required to complete the entire fracturing process, but the fracture width of the hydraulic fractures formed after each stage completed is larger than the fracture width formed by fracturing at a displacement of 12 m³/min. When the displacement increased to 16 m³/min, in addition to the obvious increase in the fracture width, after the second temporary plugging, three fracture are propagated at the same time, and the temporary plugging operation is reduced to twice. Because every time after the temporary plugging operation, it is more difficult for the fracture to propagate. To ensure that the fracture can still propagate, the bottom hole pressure will rise at this time, increasing the net pressure in the fracture, and at the same time, the fracture width will increase significantly under the action of a larger construction displacement. Therefore, by optimizing the construction displacement of dense cutting, temporary plugging and fracturing, in view of the fact that there are more perforation clusters in the seven clusters, the construction displacement must be increased to 16 m³/min and above to effectively increase the fracture width and reduce the number of temporary plugging operations at the same time to reduces the risk of operations.

The above description of the disclosed embodiments enables those skilled in the art to implement or use the disclosure. Various modifications to these embodiments will be obvious to those skilled in the art, and the general principles defined herein can be implemented in other embodiments without departing from the spirit or scope of the disclosure. Therefore, the disclosure will not be limited to the embodiments shown in this document, but should conform to the widest scope consistent with the principles and novel features disclosed in this document.

1. An optimization method for dense cutting, temporary plugging and fracturing in shale horizontal well stage, comprising:
S10: obtaining reservoir parameters, completion parameters, and fracturing construction parameters;
S20: establishing a fluid-solid coupling model of hydraulic fracturing through a discontinuous displacement method;
S30: establishing a fracture propagation model for dense cutting, temporary plugging and fracturing in shale horizontal well stage;
S40: calculating geometric parameters of dense cutting, temporary plugging and fracturing fractures in shale horizontal well stage based on the reservoir parameters, the completion parameters, and the fracturing construction parameters;
S50: optimizing the construction parameters of dense cutting, temporary plugging and fracturing in shale horizontal well stage based on results of fracture extension and temporary plugging operations.

2. The optimization method of claim 1, wherein a flow field model of the fluid-solid coupling model of hydraulic fracturing in the step S20 is:
$$\{ \begin{matrix}{p}_{pf} = \frac{0.2369 {ρ}_{s}}{{n}^{2} {d}^{4} {c}^{2}} {Q}_{c}^{2} \\ \frac{\partial p}{\partial s} = {2}^{{n}^{′} + 1} {{k}^{′} ( \frac{1 + 2 {n}^{′}}{{n}^{′}} )}^{{n}^{′}} {h}^{- {n}^{′}} {w}^{- ( 2 {n}^{′} + 1 )} {Q}^{{n}^{′}}\end{matrix} \\ {\int }_{0}^{t} {Q}_{T} ( t ) dt = {\sum }_{i = 1}^{N} {\int }_{0}^{{L}_{i} ( t )} hwds + {\sum }_{i}^{N} {\int }_{0}^{{L}_{i} ( t )} {\int }_{0}^{t} \frac{2 {C}_{L}}{\sqrt{t - τ ( s )}} dtds$$
wherein, Q_{c} is the flow rate of fracturing fluid through a perforation; Q is the fracturing fluid flow rate inside the hydraulic fracture; Q_{T} is the total fracturing fluid flow rate during fracturing construction process; p_{pf} is the friction at a horizontal wellbore perforation; p is the flow friction of the fracturing fluid in hydraulic fractures; n′ is the fluid power law exponent; k′ is the fluid viscosity index; ρₛ is fracturing fluid density; n is the number of perforations; d is perforation diameter; c is flow coefficient; L is the fracture length of the hydraulic fracture; h is the fracture height of the hydraulic fracture; w is fracture width of the hydraulic fracture; N is the number of the hydraulic fractures; C_{L} is fluid loss coefficient for the fracturing fluid; t is current fracturing construction time; τ is fracture opening time;
a stress field model of the fluid-solid coupling model of hydraulic fracturing in the step S20 is:
$$\{ \begin{matrix}{{σ}^{i}}_{s} = {\sum }_{j = 1}^{N} {T}^{ij} {{A}^{ij}}_{ss} {{D}^{j}}_{s} + {\sum }_{j = 1}^{N} {T}^{ij} {{A}^{ij}}_{sn} {{D}^{j}}_{n} \\ {{σ}^{i}}_{n} = {\sum }_{j = 1}^{N} {T}^{ij} {{A}^{ij}}_{ns} {{D}^{j}}_{s} + {\sum }_{j = 1}^{N} {T}^{ij} {{A}^{ij}}_{nn} {{D}^{j}}_{n}\end{matrix} \\ {T}^{ij} = 1 - \frac{{d}_{ij}^{3}}{{[ {d}_{ij}^{2} + {( h \text{/} 2 )}^{2} ]}^{1.5}}$$
in the formula, N is a total number of hydraulic fracture unit; ^{ij}A is a boundary strain influence coefficient matrix, describing a influence of a displacement discontinuity of the j-th fracture unit on a stress of the i-th fracture unit; σⁱ is a stress generated at the i-th fracture unit by the displacement discontinuity of the j-th fracture unit; σₛ and σₙ respectively are the tangential and normal stress along the fracture unit;
Dₛ and Dₙ respectively are the discontinuity of the tangential and normal displacement of the fracture unit; T^{ij} is a fracture height correction coefficient, used for correction the influence of the fracture height in the two-dimensional fracture model; h is a fracture height; dᵢⱼ is a distance between the midpoint of the i-th fracture unit and the j-th fracture unit.

3. The optimization method of claim 1, where in the fracture propagation model for dense cutting, temporary plugging and fracturing in shale horizontal well stage in the step S30 is:
$${K}_{e} = \frac{1}{2} cos ( \frac{α}{2} ) [ {K}_{I} ( 1 + cos ( α ) ) - 3 {K}_{II} sin ( α ) ]$$
$$\{ \begin{matrix}{K}_{I} = \frac{0.806 E \sqrt{π}}{4 ( 1 - {v}^{2} ) \sqrt{2 a}} {D}_{n}^{Tip} \\ {K}_{II} = \frac{0.806 E \sqrt{π}}{4 ( 1 - {v}^{2} ) \sqrt{2 a}} {D}_{s}^{Tip}\end{matrix} \\ \{ \begin{matrix}{σ}_{xx} = {σ}_{H} - \frac{{K}_{I}}{\sqrt{2 π r}} cos \frac{θ}{2} ( 1 - sin \frac{θ}{2} sin \frac{3 θ}{2} ) + \frac{{K}_{II}}{\sqrt{2 π r}} sin \frac{θ}{2} ( 2 + cos \frac{θ}{2} cos \frac{3 θ}{2} ) \\ {σ}_{yy} = {σ}_{H} - \frac{{K}_{I}}{\sqrt{2 π r}} cos \frac{θ}{2} ( 1 + sin \frac{θ}{2} sin \frac{3 θ}{2} ) - \frac{{K}_{II}}{\sqrt{2 π r}} sin \frac{θ}{2} cos \frac{θ}{2} cos \frac{3 θ}{2} \\ {τ}_{xy} = 0 - \frac{{K}_{I}}{\sqrt{2 π r}} sin \frac{θ}{2} cos \frac{θ}{2} cos \frac{3 θ}{2} - \frac{{K}_{II}}{\sqrt{2 π r}} cos \frac{θ}{2} ( 1 - sin \frac{θ}{2} sin \frac{3 θ}{2} ) \end{matrix} \\ \{ \begin{matrix}{σ}_{r} = \frac{{σ}_{xx} + {σ}_{yy}}{2} + \frac{{σ}_{xx} - {σ}_{yy}}{2} cos 2 θ + {τ}_{xy} sin 2 θ \\ {σ}_{θ} = \frac{{σ}_{xx} + {σ}_{yy}}{2} - \frac{{σ}_{xx} - {σ}_{yy}}{2} cos 2 θ - {τ}_{xy} sin 2 θ \\ {τ}_{r θ} = {τ}_{xy} cos 2 θ - \frac{{σ}_{xx} - {σ}_{yy}}{2} sin 2 θ \end{matrix} \\ {p}_{nf} > {σ}_{nf} + {σ}_{T} \\ \vert {τ}_{nf} \vert > {τ}_{0} + {K}_{f} ( {σ}_{nf} - {p}_{nf} )$$
wherein, Kₑ is an equivalent stress intensity factor; α is an angle of the fracture unit; E is Young's modulus; v is Poisson's ratio; α is a half-length of the fracture unit;
Dₙ^{Tip} and Dₛ^{Tip} respectively are the discontinuous quantity of normal and shear displacements of a fracture tip unit; σₓₓ, σ_{yy} and τ_{xy} respectively are a stress field at a natural fracture caused by induced stress and in-situ stress in the Cartesian coordinate system; σᵣ, σ_{θ} and τ_{rθ} respectively are a stress field at a natural fracture in the polar coordinate system established by transforming from σₓₓ, σ_{yy} and τ_{xy} to taking a contact point as a origin point; σ_{H} and σₕ are the maximum and minimum horizontal principal stresses of the shale reservoir respectively; r is the polar diameter in the polar coordinate system; θ is the approach angle between hydraulic fractures and natural fracture; K_{I} and K_{II} respectively are type I (tension type) and type II (shear type) stress intensity factor; p_{nf} is the fluid pressure at the intersection of hydraulic fractures and natural fractures; σ_{nf} and σ_{nf} respectively are the normal and tangential stress on a natural fracture wall; σ_{T} and τ₀ respectively are a tensile and shear strength of the natural fracture; K_{f} is a friction coefficient of the natural fracture wall.
